(19) United States
(12) Patent Application Publication
(10) Pub. No.: US 2006/0185234 A1
(43) Pub. Date: Aug. 24, 2006

(54) Corsage holder

(76) Inventor: Mary Fitzgerald, New York, NY (US)

Correspondence Address: CASELLA & HESPOS, 274 MADISON AVENUE, NEW YORK, NY, 10016, US

(21) Appl. No.: 11/343,448

(22) Filed: Jan. 31, 2006

Related U.S. Application Data
(60) Provisional application No. 60/655,719, filed on Feb. 22, 2005.

(51) Int. Cl. A01G 5/00

(52) U.S. Cl. 47/55

(57) ABSTRACT

A holder and method of securing a decorative object, e.g., a corsage, to a surface, e.g., clothing of a wearer, without damaging the decorative object or the surface are provided. The holder includes a vessel having at least one side wall configured to define a cavity, the vessel including an open top end for receiving the object and a closed bottom end for supporting the object in the cavity, the vessel being from of a material having magnetic properties; and a magnetic member for securing the vessel to the surface, wherein the vessel is placed on one side of the surface and the magnetic member is placed adjacent to the vessel on an opposite side of the surface gripping the surface therebetween.

### PRIORITY

This application claims priority to an application entitled “THE CORSAGE HOLDER CONSISTING OF VESSEL AND MAGNET” filed in the United States Patent and Trademark Office on Feb. 22, 2005 and assigned Ser. No. 60/655,719, the contents of which are hereby incorporated by reference.

### BACKGROUND

1. Field

The present disclosure relates generally to corsage and boutonniere holders, and more particularly, to devices and methods of securing a decorative object to a surface, e.g., clothing of a wearer, without damaging the decorative object or the surface.

2. Description of the Related Art

The word corsage and boutonniere, as used in the specification, denotes one or more natural or artificial botanical stem of flower or foliage. The stems of such botanicals are arranged to form a corsage or boutonniere by the florist schooled in the art of floristry and wrapped with conventional florist tape.

Florists and people in industries that provide flowers and services to people that use flowers for celebrations and ceremonies make and supply corsages and boutonnieres for the people attending these celebrations to be worn by a person or to decorate meaningful objects that are part of the celebrations/ceremonies.

The implementation and use of devices and methods to hold a corsage need to meet the following requirements:

Stability: The holder and attached corsage/boutonniere must remain stable and in place on the wearer/object.

Security: The corsage/boutonniere must remain secure to the holder or device used with minimal amount of friction between corsage/boutonniere and holder/device and wearer. The device must also remain secure on wearer or object.

Safety: The device, holder and/or method, must be safe to the florist working with the device, the botanical material of the corsage, the wearer, the assistant in helping the wearer use the holder/device, and to the wearer's clothing.

Speed/Ease: The device, holder and/or method must be implemented with speed, in the fewest possible steps for the florist. The wearer must also be able to use, wear and remove the holder with ease and comfort.

Aesthetic Value: The holder itself must have aesthetic appeal and high-perceived sentimental and monetary value.

Multiple Use: The device/holder must have the ability to be used again as a corsage holder or keepsake.

There are historically and presently a variety of methods and devices to wear and or incorporate a corsage/boutonniere:
1) Long straight pins to attach a corsage onto clothing
2) Decorative Stick Pin
3) Backing device with Pins
4) Metal Plate
   All of the above devices and methods achieve some of the aforementioned requirements, but none fulfill all of the requirements. The below descriptions of each of the methods/devices will clarify how each fail, and where there is a need for improvement.
   Traditional Long Straight Pin Method

A traditionally used method is to pin a corsage/boutonniere on to the wearer's clothing with long straight pins. Pinning the corsage to a piece of clothing of the wearer, commonly the chest area, but not limited to, is a difficult and potentially harmful method.

The act of pinning the corsage is difficult and awkward to perform by the wearer alone, and usually requires an assistant. The use of a sharp straight pin can result in pricks to the wearer's body as well as the fingers of the assistant. The pin also causes permanent holes in the fabric of the clothing and the weight of the corsage/boutonniere on the pin can lead to ripping and tearing of the fabric as the wearer moves.

The natural weight and bulk of the corsage/boutonniere also makes it difficult to attach to the wearer's clothing so that it remains stable and in the same position. The pin also does not provide enough balance/support to securely hold the corsage in place through the duration of the corsage/boutonniere being worn.

The act and effort to pin the corsage/boutonniere causes the wearer and assistant to repeatedly come in contact with the botanical material, thus shortening the life of the corsage/boutonniere and upsetting the design integrity of the corsage/boutonniere.

Decorative Stick Pin

A decorative stick pin consisting of a decorative holder to contain a corsage with an elongated pin presents the same problems as the traditional stick pin method. The act of sticking the pin through the wearer's clothing causes permanent damage to the wearer's clothing as well as potential accidental harm to the wearer and assistant working with the device or assisting the wearer in putting it on.

Backing Device with Pins

A device consisting of a backing to build a corsage onto with one or multiple pins to stick through a wearer's clothing is disclosed in U.S. Pat. No. 3,982,303 issued to Shulkin on Sep. 28, 1976. Backing devices are time consuming for the florist to work with and results in a bulky corsage. The act of constructing the corsage onto the backing also requires extra contact with the botanical materials, resulting in possible damage to the botanical materials. The bulk of the overall corsage also causes unnecessary weight making it uncomfortable to wear, difficult to put on and not aesthetically pleasing. The act of pinning with one or multiple pins results in damage to the wearer's clothes and potential harm to the assistant and wearer.

Metal Plate

One of the first options to follow the straight pin is a device consisting of a body of pliable metal with laterally extending fingers that fold over the corsage to hold it into place. Such a device is disclosed in U.S. Pat. No. 2,242,976 issued to Kaber on Jul. 2, 1940. The metal body has an elongated extension that can bend over or be tucked into a desired hair style or into clothing or an object to display the corsage. This particular device is not commonly used today as people do not usually wear full corsages in the hair or have pockets to insert the device into. The device has many functional deficiencies as well. The body of the device is a flat, manually pliable plate that supports the corsage with blunt ended projections extending laterally. The projections—4 tabs, 2 at each end—fold over the corsage and hold corsage in place. The plate is flat, long and thin with straight edges at the side (though rounded at the end of the tabs/projections). The edges of the plate scrape the wearer when putting on/removing the corsage, and while corsage is worn. As the corsage is placed on the plate to secure it, the projections/tabs are folded over to hold the corsage. The flat and straight side edges of the projections/tabs scratch and damage the corsage and botanical material, shortening the life of the botanicals and upsetting the design integrity of the corsage. The projections/tabs are not adjustable, limiting the placement of the corsage and direction the corsage faces. The metal of the plate and projections/tabs are only pliable/malleable to a certain degree. Thus the bent tabs do not hold the corsage completely secure, allowing room for the corsage to move around, causing friction between the corsage and the plate/tabs as well as to the wearer's wrist, thus shortening the life span of the botanicals and causing discomfort to the wearer. It also limits the times a florist can bend/re-bend the tabs, as the tabs become permanently creased and will easily break off.

Metal Plate with Magnet

An improvement upon the stickpin method is employing a magnet with the metal plate. Though the problems associated with the stickpin are solved (the damage to the wearers clothing as well as potential harm to assistant and wearer), the use of a modified metal plate presents the same problems as mentioned previously above.

### SUMMARY

A holder for an ornamental object and method for securing same to a surface are provided. The holder of the present disclosure includes a vessel for holding or supporting a decorative or ornamental object, e.g., a corsage, and a magnetic member for securing the vessel to a surface, e.g., clothing of the individual. The decorative vessel is composed of a metal that is molded/formed, in one embodiment, into a semi-circular shape which is tapered from an open end to a closed end. The vessel, with or with out decorative embellishments, contains, holds and supports a corsage, boutonniere or any other ornamental object. The vessel includes a flat shaped back. The flat shaped back of the vessel, allows the vessel to lie flush against the fabric or object of the person wearing the corsage/boutonniere. The magnetic member is the size and shape relative and in proportion to the size and shape of the holder. The flat shaped back of the vessel allows the vessel to lie flush against the fabric of the wearer's clothing maximizing the contact surface with the magnetic member thus creating stability and support. The magnetic member firmly, securely and safely supports the holder that contains the corsage/boutonniere in position. The decorative holder is placed on the outside visible area of the wearer's clothing or object. The clothing or object is positioned between the decorative holder and magnetic member. The magnet is placed on the inside or back of the clothing or object, directly behind the decorative holder.

According to one aspect of the present disclosure, a holder for securing a decorative object to a surface is provided. The holder includes a vessel having at least one side wall configured to define a cavity, the vessel including an open top end for receiving the object and a closed bottom end for supporting the object in the cavity, the vessel being formed of a material having magnetic properties; and a magnetic member for securing the vessel to the surface, wherein the vessel is placed on one side of the surface and the magnetic member is placed adjacent to the vessel on an opposite side of the surface gripping the surface therebetween. The at least one side wall includes at least one flat portion for maximizing contact between the vessel and the surface and the magnetic member includes at least one flat portion for maximizing contact between the magnetic member and the surface.

In another aspect, the magnetic member is substantially the same size and shape of the at least one flat portion of the vessel.

In a further aspect, the at least one side wall tapers from the open top end to the closed bottom end making the vessel suitable for supporting a corsage.

According to another aspect of the present disclosure, a holder for securing a corsage to an article of clothing includes a vessel having at least one side wall configured to define a cavity, the vessel including an open top end for receiving the corsage and a closed bottom end for supporting the corsage in the cavity, the vessel being formed of a material having magnetic properties; and a magnetic member for securing the vessel to the article of clothing, wherein the vessel is placed on one side of the article of clothing and the magnetic member is placed adjacent to the vessel on an opposite side of the article of clothing gripping the article of clothing therebetween.

In a further aspect of the present disclosure, a holder for securing a decorative object to a surface includes a vessel having at least one side wall configured to define a cavity, the vessel including an open top end for receiving the object and a closed bottom end for supporting the object in the cavity; a back plate being formed of a material having magnetic properties, the back plate being coupled to the vessel; and a magnetic member for securing the vessel to the surface, wherein the vessel is placed on one side of the surface and the magnetic member is placed adjacent to the vessel on an opposite side of the surface gripping the surface therebetween.

### BRIEF DESCRIPTION OF THE DRAWINGS

The above and other aspects, features and advantages of the present disclosure will become more apparent in light of the following detailed description when taken in conjunction with the accompanying drawings in which:

FIG. 1 is a perspective view of a holder for a decorative or ornamental object according to an embodiment of the present disclosure, wherein the holder is affixed to an individual's clothing;

FIG. 2 is a front view of a vessel of the holder of the present disclosure;

FIG. 3 is a back view of the vessel of the holder of the present disclosure;

FIG. 4 is a perspective view of a magnetic member of the holder of the present disclosure;

FIG. 5 is a perspective view of the holder of the present disclosure wherein a portion of clothing is held between the vessel and magnetic member;

FIG. 6 is a side view of the vessel and magnetic member of the holder of the present disclosure;

FIG. 7 is a bottom view of the holder;

FIG. 8 is a perspective view of a holder for a decorative object according to another embodiment of the present disclosure; and

FIG. 9 is an exploded view of the holder shown in FIG. 8.

### DETAILED DESCRIPTION

Preferred embodiments of the present disclosure will be described hereinbelow with reference to the accompanying drawings. In the following description, well-known functions or constructions are not described in detail to avoid obscuring the disclosure in unnecessary detail. Throughout the figures, like reference numerals represent like elements.

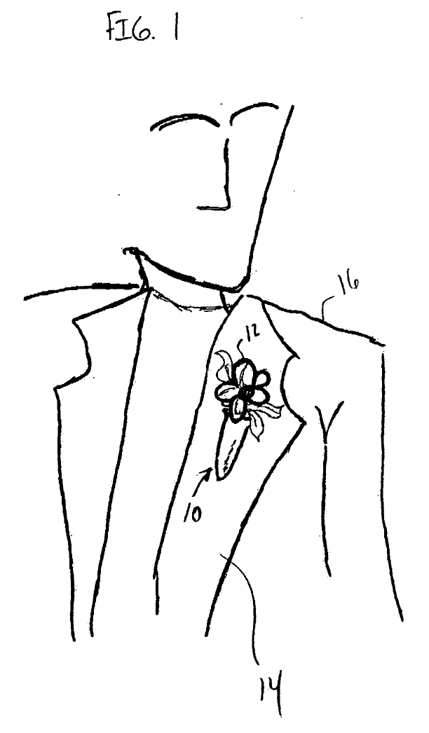

A holder and method of securing a decorative object, e.g., a corsage, to a surface, e.g., clothing of a wearer, without damaging the decorative object or the surface are provided. Referring to FIG. 1, a holder for securing a decorative object to an article of clothing is illustrated and indicated generally by reference numeral 10. The holder 10 contains and supports a corsage or boutonniere 12 to an article of clothing. Here, the holder is affixed to a lapel 14 of a jacket 16.

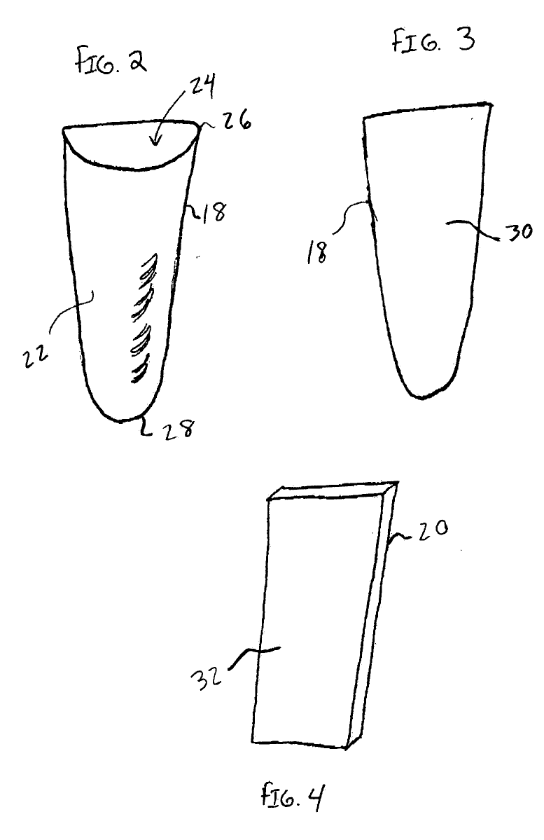

Referring to FIGS. 2-6, the holder 10 includes a vessel 18 for receiving and supporting a decorative object and a magnetic member 20 for securing the vessel 18 to a surface such as a lapel of a jacket, a piece of cloth of a dress, etc. The vessel 18 includes at least one side wall 22 formed to define a cavity 24 into which a decorative object may be placed. The vessel will be formed to include an open top end 26 for receiving the object and a closed bottom end 28 for supporting the object in the vessel 18. It is to be appreciated that the vessel may be formed in any shape that will accomplish the function of receiving and supporting an object, for example, the vessel may be shaped as a cylinder with one continuous circular side wall. As another example, the vessel may be formed in a rectangular shape with four side walls. Other shapes and configurations are contemplated by the present disclosure.

In the embodiment shown in FIGS. 2-6, the vessel 18 is formed with a semi-circular side wall 22 with a portion of the side wall being flat 30. As will be described in more detail below, the flat shaped back wall 30 will ensure maximum contact with the surface and maximum attraction when placed adjacent to the magnetic member 20. The side wall 22 tapers from the open top end 26 down to the closed bottom end 28 being optimally formed for receiving a lower end of a corsage, e.g., a stem. The vessel 18 will be formed from a metal having magnetic properties, e.g., a ferrous metal such as iron, steel, nickel, cobalt, etc. When the vessel is placed adjacent to the magnetic member 20, e.g., with a piece of clothing therebetween, the magnetic material of the vessel and the magnetic member 20 will attract each other and securing the holder 10 to the clothing therebetween.

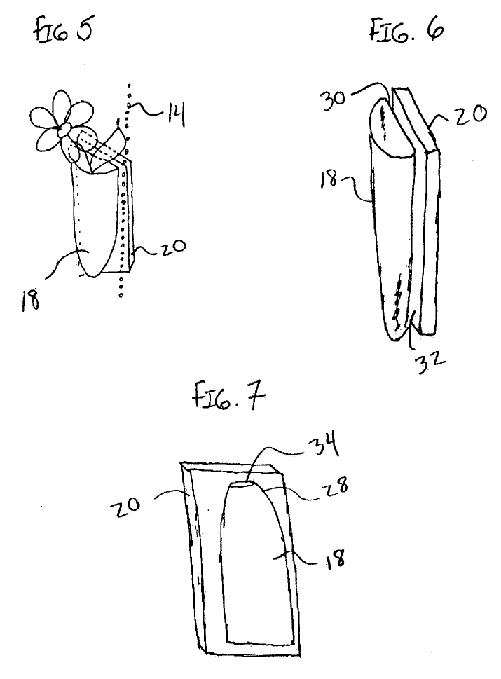

The magnetic member 20 is a permanent magnetic and includes at least one flat side 32 for maximizing contact with a surface, e.g., a piece of clothing. The magnetic member may be any known type of conventional permanent magnetic, e.g., neodymium iron boron, samarium cobalt, alnico, ceramic or ferrite. Preferably, the magnetic member will be of substantially the same size and shape of the back wall 30 of the vessel 18 to ensure maximum attraction between the vessel 18 and magnetic member 20. In the embodiment of FIGS. 2-6, the magnetic member 20 includes a flat surface 32 the size of which is slightly larger than the flat back wall 30 of the vessel 18. As shown in FIGS. 5 and 6, the magnetic member 20 is in full contact with the back wall 30 of the vessel 18 to ensure maximum attraction of the vessel 18 and member 20 and therefore ensure stability of the holder 10 onto the wearer.

In use, a corsage or boutonniere 12 is assembly by a florist as is known in the art. The corsage 12 is disposed in the cavity 24 of the vessel 18. An appropriate surface for placement of the holder is selected, for example, a lapel 14 of a jacket 16 or a fabric of a dress in the chest/shoulder area. The flat back wall 30 of the vessel 18 is placed in contact with a front side of the surface. The magnetic member 20 is then placed adjacent to the vessel on a back or opposite side of the surface. The magnetic member 20 will attract the back wall 30 of the vessel gripping the surface 14 therebetween and securing the holder to the wearer.

Referring to FIG. 7, an aperture 34 may be formed in the bottom end 28 of the vessel 18. In this embodiment, the aperture 34 will allow a stem of a flower or corsage to pass through and be visible. This embodiment contemplates other uses for the holder 10 besides flowers, corsages and the like. For example, a flag or pendant having a stick portion for support may be secured to a wearer by placing the stick in the cavity 24 of the vessel and allowing the stick portion to pass through the aperture 34.

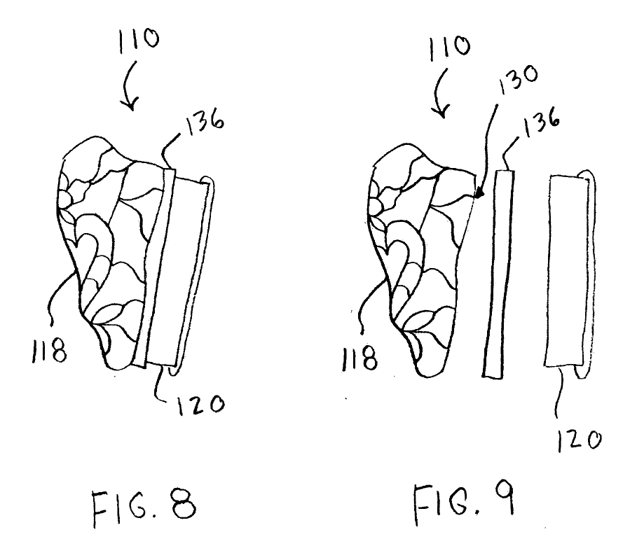

Referring to FIGS. 8 and 9, a holder 110 for securing a decorative object to a surface according to another embodiment of the present disclosure is illustrated. In this embodiment, the vessel may be formed from material other than a material having magnetic properties. The vessel 118 may be molded from a plastic or resin material. Furthermore, the vessel 118 may be formed from a precious or semi-precious material such as gold, silver, etc. To secure the holder 110 to a surface, a generally rectangular, flat back plate 136 made from a material having magnetic properties, e.g., a ferrous material, is coupled to the back wall 130 of the vessel 110. Once the back plate 136 is secured to the vessel, holder 118 will operate as described above.

In a further embodiment, the back plate 136 may be a permanent magnet with the member 120 either being a member made from a ferrous material or a magnetic having an opposite polarity from the polarity of the back plate. Although the holder will act as described above, the vessel will be able to be displayed on any surface having magnetic properties. For example, after being employed as a corsage holder, the holder with magnetic back plate may be placed on a door of a refrigerator, metal surface of an automobile, or any surface to display the holder as a keepsake.

This present disclosure meets all of the aforementioned requirements of a corsage holder/device and method. The holder of the present disclosure will assist the florist as well as the wearer.

It will assist the florist in the following ways:

Safety to Florist: There are no sharp pinpoints making it easy to work with and to attach to a wearer.

Support: The flat shaped back of the vessel allows the vessel to lie flush against the fabric maximizing the contact surface with the magnetic member thus creating stability and support.

Safety to Botanical Material: The semi-circular shape with tapered end of the vessel provides a suitable size space for the corsage/boutonniere to fit securely with minimal amount of fiction. The flat shaped back of the vessel allows the vessel to lie flush against the fabric maximizing the contact with the magnetic member thus creating stability and support, thus minimizing the fiction of the corsage/boutonniere as the wearer moves about.

High Aesthetic Value: The decorative nature of the vessel lends to the appearance of jewelry.

It will assist the wearer in the following ways:

Ease to Put On/Remove: The wearer is able put on and remove the holder without assistance.

Safety: There are no sharp pinpoints on the holder to cause personal injury or damage to material when putting on or taking off.

Comfort: The wearer is able to move around encumbered because the holder stays securely in place due to the flat shaped back of the vessel allowing the vessel to lie flush against the fabric maximizing the contact surface with the magnetic member.

High Aesthetic Value: The holder is a keepsake to reuse.

While the disclosure has been shown and described with reference to certain preferred embodiments thereof, it will be understood by those skilled in the art that various changes in form and detailed may be made therein without departing from the spirit and scope of the disclosure as defined by the appended claims.

What is claimed is:

1. A holder for securing a decorative object to a surface, the holder comprising:
a vessel having at least one side wall configured to define a cavity, the vessel including an open top end for receiving the object and a closed bottom end for supporting the object in the cavity, the vessel being formed of a material having magnetic properties; and
a magnetic member for securing the vessel to the surface, wherein the vessel is placed on one side of the surface and the magnetic member is placed adjacent to the vessel on an opposite side of the surface gripping the surface therebetween.

2. The holder as in claim 1, wherein the at least one side wall includes at least one flat portion for maximizing contact between the vessel and the surface.

3. The holder as in claim 2, wherein the magnetic member includes at least one flat portion for maximizing contact between the magnetic member and the surface.

4. The holder as in claim 2, wherein the magnetic member is substantially the same size and shape of the at least one flat portion of the vessel.

5. The holder as in claim 1, wherein the bottom end of the vessel includes an aperture.

6. The holder as in claim 1, wherein the at least one side wall tapers from the open top end to the closed bottom end.

7. The holder as in claim 6, wherein the at least one side wall is generally semi-circular and includes at least one flat portion for maximizing contact between the vessel and the surface.

8. The holder as in claim 1, wherein the vessel is formed from a ferrous material.

9. The holder as in claim 3, wherein the vessel includes a generally rectangular flat back plate coupled to the flat portion of the vessel, the back plate being formed from a material having magnetic properties.

10. A holder for securing a corsage to an article of clothing, the holder comprising:
a vessel having at least one side wall configured to define a cavity, the vessel including an open top end for receiving the corsage and a closed bottom end for supporting the corsage in the cavity, the vessel being formed of a material having magnetic properties; and
a magnetic member for securing the vessel to the article of clothing, wherein the vessel is placed on one side of the article of clothing and the magnetic member is placed adjacent to the vessel on an opposite side of the article of clothing gripping the article of clothing therebetween.

11. The holder as in claim 10, wherein the at least one side wall includes at least one flat portion for maximizing contact between the vessel and the article of clothing.

12. The holder as in claim 11, wherein the magnetic member includes at least one flat portion for maximizing contact between the magnetic member and the article of clothing.

13. The holder as in claim 11, wherein the magnetic member is substantially the same size and shape of the at least one flat portion of the vessel.

14. The holder as in claim 10, wherein the bottom end of the vessel includes an aperture.

15. The holder as in claim 10, wherein the at least one side wall tapers from the open top end to the closed bottom end.

16. A holder for securing a decorative object to a surface, the holder comprising:
a vessel having at least one side wall configured to define a cavity, the vessel including an open top end for receiving the object and a closed bottom end for supporting the object in the cavity;
a back plate being formed of a material having magnetic properties, the back plate being coupled to the vessel; and
a magnetic member for securing the vessel to the surface, wherein the vessel is placed on one side of the surface and the magnetic member is placed adjacent to the vessel on an opposite side of the surface gripping the surface therebetween.

17. The holder as in claim 16, wherein the back plate is a permanent magnet.

18. The holder as in claim 16, wherein the back plate includes at least one flat portion for maximizing contact between the back plate and the surface.

19. The holder as in claim 16, wherein the magnetic member includes at least one flat portion for maximizing contact between the magnetic member and the surface.

20. The holder as in claim 16, wherein the magnetic member is substantially the same size and shape of the back plate.
